(19) United States
(12) Patent Application Publication
(10) Pub. No.: US 2025/0272245 A1
(43) Pub. Date: Aug. 28, 2025

(54) DRAM CACHE CLEANING

(71) Applicant: Rambus Inc., San Jose, CA (US)

(72) Inventors: Wendy ELSASSER, Austin, TX (US); Michael Raymond Miller, Raleigh, NC (US); Steven C. Woo, Saratoga, CA (US)

(21) Appl. No.: 19/011,310

(22) Filed: Jan. 6, 2025

Related U.S. Application Data
(60) Provisional application No. 63/557,374, filed on Feb. 23, 2024.

(51) Int. Cl. G06F 12/0891

(52) U.S. Cl. CPC G06F 12/0891

(57) ABSTRACT

A dynamic random access memory (DRAM) device includes functions configured to aid with operating the DRAM device as part of data caching functions. The DRAM, as part of a command seeking to access cache line data, provides information (cache hints) about the cache line status (e.g., valid/invalid, modified/unmodified, etc.) of cache lines that were not directly addressed by the command. These cache hints may be used to initiate operations/command, based on the cache hints, for “cleaning” modified (a.k.a., “dirty”) cache lines by reading the modified data and providing it to other memory levels (e.g., a higher cache level, main memory, backing store, etc.). The DRAM device implements commands that, based on information about a plurality of cache lines (e.g., cache lines stored in the same way of a set associative cache) select a cache line to be cleaned and/or provided for provision to other memory levels.

### BRIEF DESCRIPTION OF THE DRAWINGS

FIG. 1 is a block diagram illustrating a memory system.

FIG. 2A is a diagram illustrating an example placement of tag information entries in a row of a dynamic random access memory (DRAM) bank.

FIG. 2B is a diagram illustrating a first example of concurrently accessed tag information entries.

FIG. 2C is a diagram illustrating a second example of concurrently accessed tag information entries.

FIG. 3 is a diagram illustrating an example placement of cache line data in a row of a DRAM bank.

FIGS. 4A-4E illustrate example bus communications for cache access operations.

FIGS. 5A-5C are diagrams illustrating example cache cleaning commands/operations.

FIG. 6 is a flowchart illustrating an example method of providing cache line status hints.

FIG. 7 is a flowchart illustrating an example method of receiving cache line status hints.

FIG. 8 is a flowchart illustrating an example method of providing multiple cache line status indicators.

FIG. 9 is a flowchart illustrating a first example method of transmitting a modified cache line.

FIG. 10 is a flowchart illustrating a second example method of transmitting a modified cache line.

FIG. 11 is a flowchart illustrating a third example method of transmitting a modified cache line.

FIG. 12 is a flowchart illustrating an example method of cleaning a modified cache line.

FIG. 13 is a block diagram illustrating a processing system.

### DETAILED DESCRIPTION OF THE EMBODIMENTS

In an embodiment, a dynamic random access memory (DRAM) device includes functions configured to aid with operating the DRAM device as part of data caching functions. The DRAM may be configured to, as part of a command seeking to access cache line data (cache data access command), provide information (cache hints) about the cache line status (e.g., valid/invalid, modified/unmodified, etc.) of cache lines that were not directly addressed by the command. These cache hints may be used to initiate operations/commands, based on the cache hints, for “cleaning” modified (a.k.a., “dirty”) cache lines by reading the modified data and providing it to other memory levels (e.g., a higher cache level, main memory, backing store, etc.). The DRAM device may also implement commands that, based on information about a plurality of cache lines (e.g., cache lines stored in the same way of a set associative cache) select a cache line to be cleaned and/or provided for provision to other memory levels.

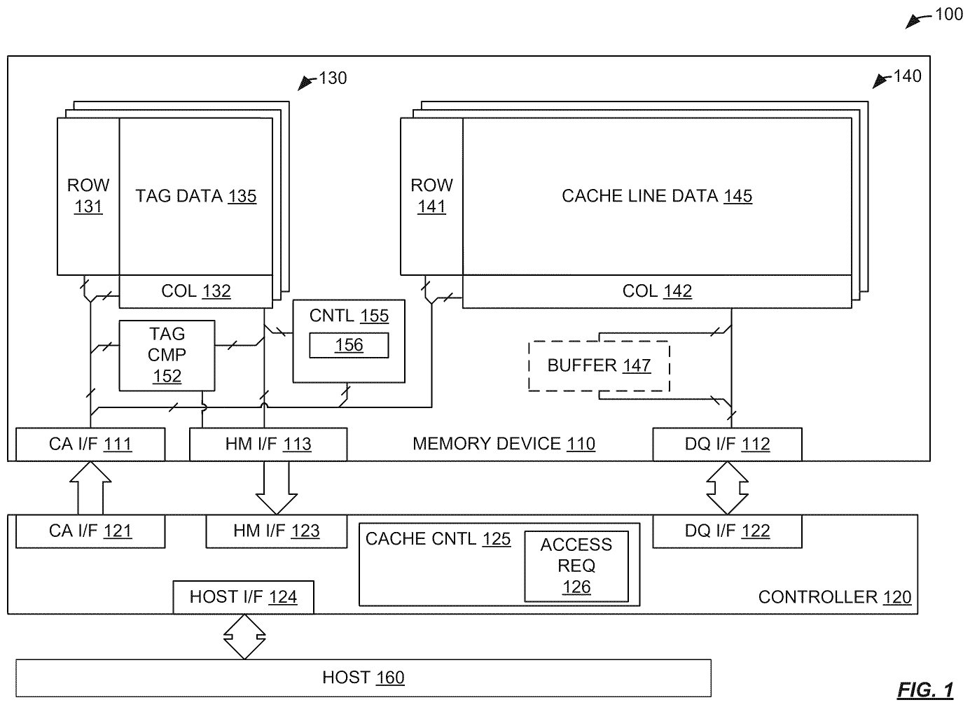

FIG. 1 is a block diagram illustrating a memory system. In FIG. 1, memory system 100 comprises memory device 110, memory controller 120, and host 160. Memory device 110 includes command/address (CA) interface 111, data (DQ) interface 112, hit/miss (HM) interface 113, memory arrays (banks) 130, memory arrays (banks) 140, optional flush buffer 147, tag compare circuitry 152, and control circuitry 155. Control circuitry 155 includes mode registers 156. The rows and columns of each of memory banks 130 and memory banks 140 may be organized into rows and columns of memory array tiles (MATs). Each of memory banks 130 includes row circuitry 131, column circuitry 132, and a tag data storage array 135. Each of memory banks 140 includes row circuitry 141, column circuitry 142, and a cache line data storage array 145.

Tag data storage array 135 stores tag information entries (TIEs) corresponding to cache lines stored by cache line data storage array 145. Tag information entries stored by tag data storage array may include tag values and tag metadata. Tag metadata may include information related to the status of the tag information entry and/or the corresponding cache line stored by cache line data storage array 145. Information included in tag metadata may include, for example, whether the corresponding cache line is valid/invalid, clean/dirty, set associative replacement policy information (e.g., least recently used), and/or cache coherency state information (e.g., modified, exclusive, shared, owner, invalid, etc.).

In an embodiment, tag data storage array 135 may store tag information entries corresponding to cache lines fetched by other cache memories to avoid unnecessary cache snooping operations. In an embodiment, memory device 110 and/or controller 120 may be configured to perform snoop-filtering operations/functions. A snoop-filter function and/or circuitry saves tag information (e.g., address, owner, state such as shared/exclusive/etc.) about cache lines to avoid unnecessary snooping under multi-socket CPUs. In this configuration, some of the tag information in tag memory banks 130 may not be related to cache lines in data memory banks 140 of memory device 110 and is instead related to cache lines fetched by other CPU caches.

Memory controller 120 includes CA interface 121, DQ interface 122, hit/miss (HM) interface 123, host interface 124, and cache control circuitry 125. Cache control circuitry 125 includes access request circuitry 126. Host interface 124 of controller 120 is operatively coupled to host 160. Host 160 and/or controller 120 may be operatively coupled to additional cache levels (not shown in FIG. 1), main memory (not shown in FIG. 1), and/or backing store (not shown in FIG. 1).

CA interface 121 of controller 120 is operatively coupled to CA interface 111 of memory device 110. CA interface 121 of controller 120 is operatively coupled to CA interface 111 of memory device 110 to at least communicate, from controller 120, commands, addresses, and cache tag query values to memory device 110. DQ interface 122 of controller 120 is operatively coupled to DQ interface 112 of memory device 110. DQ interface 122 of controller 120 is operatively coupled to DQ interface 112 of memory device 110 to communicate data (e.g., cache lines, dirty cache lines, cache line fill data) between controller 120 and memory device 110. HM interface 123 of controller 120 is operatively coupled to HM interface 113 memory device 110. HM interface 123 of controller 120 is operatively coupled to HM interface 113 memory device 110 to at least communicate, from memory device 110 and to controller 120, indicators of cache tag compare results (i.e., hits or misses), whether cache accesses were to clean or dirty cache lines (e.g., cache flag indicators), and information about one or more cache lines accessed by, but not the subject of, the command (e.g., cache hints). In an embodiment, HM interface 123 of controller 120 is operatively coupled to HM interface 113 memory device 110 to, in some cases (e.g., when the tag query value associated with the command results in a “hit” and another tag information entry accessed by the command indicates a “dirty” cache line), communicate a tag value stored by tag data storage array 135 (e.g., the tag value associated with the “dirty” cache line) from memory device 110 to controller 120 that is not associated with the cache line that was the subject of the command (i.e., the cache line that was the subject of the “hit”).

Memory controller 120 and memory device 110 may be integrated circuit type devices, such as are commonly referred to as “chips”. A memory controller, such as memory controller 120, manages the flow of data going to and from memory devices and/or memory modules. Memory device 110 may be a standalone device, or may be a component of a memory module such as a DIMM module used in servers. Memory device 110 may be, or be part of, a component having a “stack” of memory devices. Memory device 110 may be a device that adheres to, or is compatible with, a dynamic random access memory (DRAM) specification. A memory controller can be a separate, standalone chip, or integrated into another chip. For example, a memory controller 120 may be included on a single die with a microprocessor, included as a chip co-packaged with one or more microprocessor chips, included as part of a more complex integrated circuit system such as a block of a system on a chip (SOC), or be remotely coupled to one or more microprocessors via a fabric interconnect or other type of interconnect.

CA interface 111 of memory device 110 is operatively coupled to the row circuitry 131 of each of memory banks 130, the column circuitry 132 of each of memory banks 130, and tag compare circuitry 152. CA interface 111 of memory device 110 is also operatively coupled to the row circuitry 141 of each of memory banks 140, the column circuitry 142 of each of memory banks 140, and control circuitry 155. CA interface 111 is operatively coupled to each of row circuitry 131 of memory banks 130 to at least to activate rows in one or more of memory banks 130. CA interface 111 is operatively coupled to the column circuitry 132 of each of memory banks 130 to at least sense values from activated rows, and to decode and provide the values of selected banks and columns to other circuitry of memory device 110 (e.g., tag compare circuitry 152, tag error detection and correction (EDC) circuitry, DQ interface 112, etc.) CA interface 111 is operatively coupled to the column circuitry 132 of each of memory banks 130 to at least allow accessing of tag information entries stored in the tag data storages arrays 135 of memory banks 130 and to at least provide tag compare circuitry 152 with stored tag values from the tag data storages arrays 135 of memory banks 130. CA interface 111 is operatively coupled to tag compare circuitry 152 to at least provide tag compare circuitry 152 with tag query values indicated by commands.

CA interface 111 is operatively coupled to each of row circuitry 141 of memory banks 140 to at least activate rows in one or more of memory banks 140. CA interface 111 is operatively coupled to the column circuitry 142 of each of memory banks 140 to at least sense values from activated rows, and to decode and provide the values of selected banks and columns to other circuitry of memory device 110 (e.g., data EDC circuitry, DQ interface 112, etc.) CA interface 111 is operatively coupled to the column circuitry 142 of each of memory banks 140 to at least allow accessing of cache line data stored in the cache line data storages arrays 145 of memory banks 140 and to at least communicate cache line data with DQ interface 112.

Column circuitry 142 and DQ interface 112 may, in some embodiments, be operatively coupled with flush buffer 147. Flush buffer 147 may be operatively coupled to column circuitry 142 to receive dirty cache line data from memory banks 140. Flush buffer 147 may be operatively coupled to DQ interface 112 to transmit dirty cache line data. Flush buffer 147 may hold dirty cache line data for a period of time rather than driving the dirty cache line data a short time after the access (e.g., ACTRD) or write (e.g., ACTWR) command that triggered, for example, a dirty miss. Flush buffer 147 may also manage DQ bus turnarounds to minimize the impact of these bus turnarounds. Flush buffer 147 may manage dirty cache lines and DQ bus turnarounds in a manner similar to traditional write buffers. In an embodiment, controller 120 may use a command to read dirty cache line data from flush buffer 147. In an embodiment, controller 120 and memory device 110 may have a common set of rules (e.g., state machine) to transmit data from flush buffer 147 to controller 120. For example, data from flush buffer 147 may be transmitted in the data bus slot that would have been used by a read command that was not used because the command resulted in a miss clean. In another example, data from flush buffer 147 may be transmitted during refresh operations performed by memory device 110.

Column circuitry 132 and column circuitry 142 may have different decoding functions. For example, the different decoding functions performed by column circuitry 132 and column circuitry 142 may allow different arrangements of data and/or EDC information (i.e., fields) between memory banks 130 and memory banks 140. Column circuitry 132 may decode a column address and provide the cache tags and metadata from addressed tag information entries to tag compare circuitry 152 and tag EDC information to tag EDC circuitry (not shown in FIG. 1). Similarly, column circuitry 142 may decode a column address and provide the addressed data EDC information and the cache line data to data EDC circuitry (not shown in FIG. 1), and also provide cache line data (e.g., as selected by control circuitry 155 based on a result from tag compare circuitry 152) to DQ interface 112.

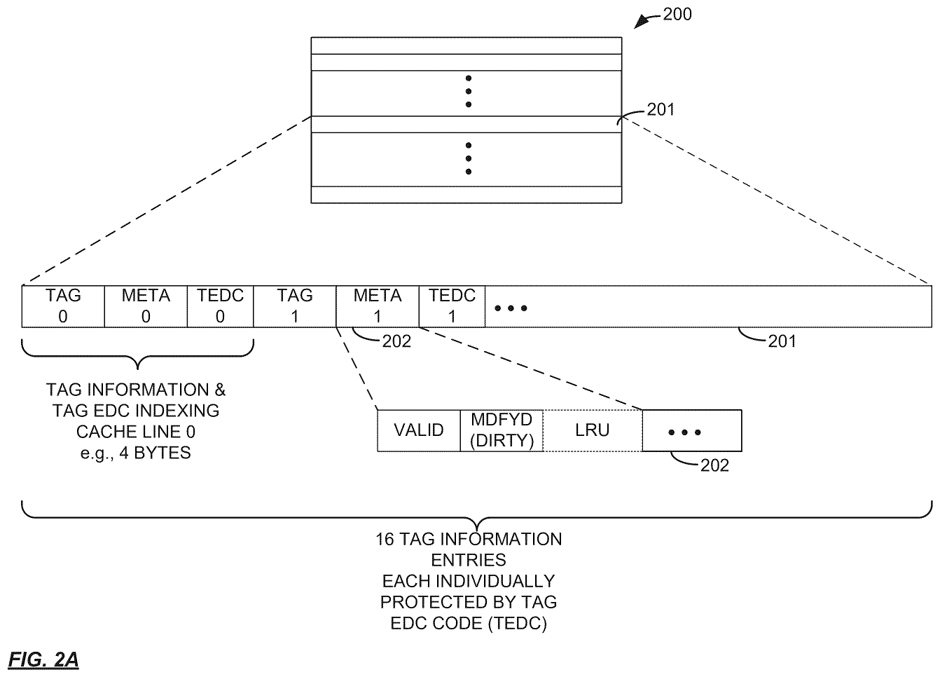

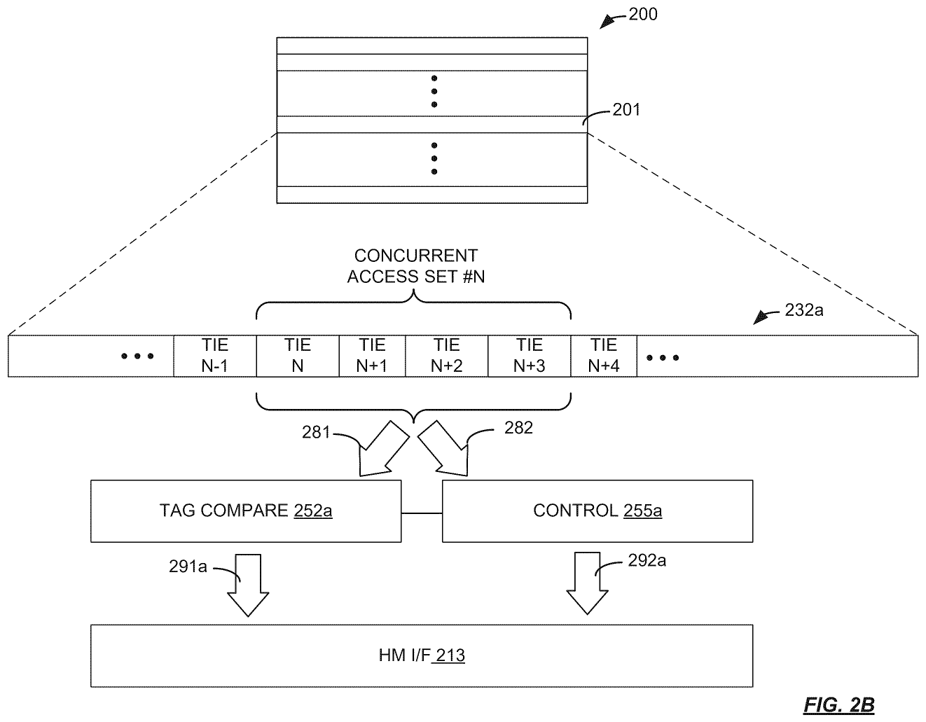

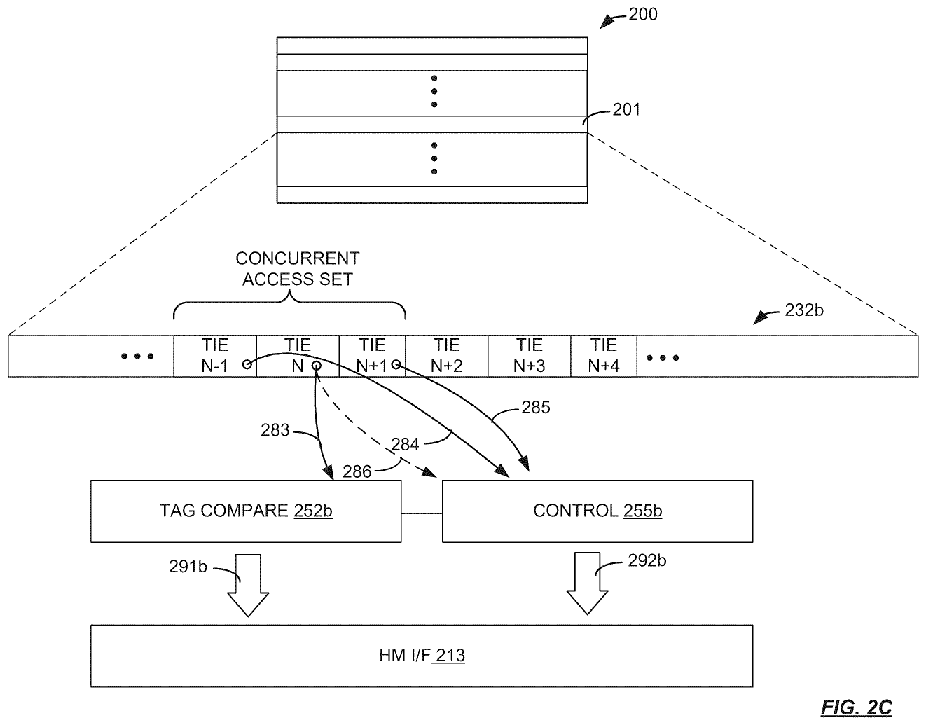

FIG. 2A is a diagram illustrating an example placement of tag information in a row of a dynamic random access memory (DRAM) bank. In FIG. 2A, the data placement of tag information entries and cache EDC information into the rows of a memory bank 200 (e.g., each of memory banks 130) is illustrated. In particular, the example data placement into row 201 of memory bank 200 is illustrated. In FIG. 2A, the tag, metadata, and tag EDC information for the tag information entries stored in row 201 is illustrated starting at the leftmost position in row 201 starting with tag information entry #0 comprising a first tag (TAG0), first metadata (META 0), and first tag EDC information (TEDC0) for cache line 0, then proceeding to the next position to the right with tag information entry #1 comprising a second tag (TAG1), second metadata (META1), and second tag EDC information (TEDC1) for cache line 1, and so on. Further illustrated in FIG. 2A is an example metadata contents and placement. In FIG. 2A, metadata information (e.g., META0, META1, etc.) stored by row 201 for the associated cache lines are illustrated by example by META1 202. Starting at the leftmost position in META1, metadata fields include a valid/invalid indicator (e.g., valid flag), a modified state indicator (e.g., dirty flag), and, in some embodiments, least-recently used information.

FIG. 2B is a diagram illustrating a first example of concurrently accessed tag information entries. In FIG. 2B, tag information entries stored in row 201 are concurrently read and held concurrently by column circuitry 232a. This is illustrated in FIG. 2B by tag information entries (TIEs) N−1 to N+4 being shown in column circuitry 232a. From column circuitry 232a, a subset of the TIEs N to N+3 (a.k.a., an access set) stored by column circuitry 232a is provided to tag compare circuitry 252a and control circuitry 255a. This is illustrated in FIG. 2B by arrow 281 running from access set #N, comprising TIEs N to N+3, to tag compare circuitry 252a and arrow 282 running from access set #N to control circuitry 255a.

In an embodiment, a portion (e.g., tag value, metadata, and/or only selected metadata) rather than all of the information in TIEs N to N+3 of the access set are provided to tag compare circuitry 252a and/or control circuitry 255a. In an embodiment, the TIEs of access sets correspond to the sets of a set associative cache. In other words, for example, the access set #N having TIEs N to N+3 may correspond to tag information entries for associative set #N of a cache that is organized and/or functions a 4-way set associative cache. Other cache set associativity's are contemplated (e.g., 2-way, 8-way, etc.).

Tag compare circuitry 252a compares the tag values of TIEs in the access sets to tag query values. When one of the tag values in an access set matches a tag query value, an indicator of a tag “hit” is transmitted by HM interface 213. If none of the tag values in an access set matches the tag query value, an indicator of a tag “miss” is transmitted via HM interface 213. This is illustrated in FIG. 2B by arrow 291a running from tag compare circuitry 252a to HM interface 213.

Control circuitry 255a processes at least some of the metadata (e.g., modified/unmodified indicator, LRU information, etc.) in the TIEs of the access set to determine whether, and/or which, cache line(s) associated with the TIEs of the access set are likely (or most likely) to be evicted. For example, control circuitry 255a may process the TIEs of the access set to determine which cache line(s) (if any) is in a modified state. In another example, control circuitry 255a may process the TIEs of the access set to determine which cache line (if any) is in a modified state and is also the least recently used cache line associated with the current access set. Based on control circuitry 255a determining that at least one cache line associated with the current access set is in a modified state, an indicator of the modified state is transmitted via HM interface 213. This is illustrated in FIG. 2B by arrow 292a running from tag compare circuitry 252a to HM interface 213. In an embodiment, based on control circuitry 255a determining that at least one cache line associated with the current access set is in a modified state, HM interface 213 may also transmit an indicator of which cache line(s) (e.g., tag value or tag values) are in a modified state.

FIG. 2C is a diagram illustrating a second example of concurrently accessed tag information entries. In FIG. 2C, tag information entries stored in row 201 are concurrently read and held concurrently by column circuitry 232b. This is illustrated in FIG. 2C by tag information entries (TIEs) N−1 to N+4 being shown in column circuitry 232b. TIEs N−1 to N+1 may comprise an example access set. From column circuitry 232b, TIE N stored by column circuitry 232b is provided to tag compare circuitry 252b. At least one TIE (e.g., TIE N−1 and TIE N+1 or TIE N−1 to TIE N+1) stored by column circuitry 232b is provided to control circuitry 255b. This is illustrated in FIG. 2C by arrow 284 running from TIE N−1 to control circuitry 255b, arrow 285 running from TIE N+1 to control circuitry 255b, and (optional) dashed arrow 286 running from TIE N to control circuitry 255b.

In an embodiment, a portion (e.g., tag value, metadata, and/or only selected metadata) rather than all of the information in TIEs N−1 to N+1 of the access set are provided to tag compare circuitry 252b and/or control circuitry 255b. In an embodiment, the TIEs stored in row 201 may correspond to tag information entries for a cache that is organized and/or functions a direct mapped cache.

Tag compare circuitry 252b compares the tag values from the directly addressed TIE (e.g., TIE N) to tag query values. When one of the tag values in the directly addressed TIE matches a tag query value, an indicator of a tag “hit” is transmitted by HM interface 213. If the tag value of the directly addressed TIE does not match the tag query value, an indicator of a tag “miss” is transmitted via HM interface 213. This is illustrated in FIG. 2C by arrow 291b running from tag compare circuitry 252b to HM interface 213.

Control circuitry 255b processes at least some of the metadata (e.g., modified/unmodified indicator, LRU information, etc.) in the TIEs of the access set to determine whether, and/or which, cache line(s) associated with the TIEs of the access set are likely (or most likely) to be evicted. For example, control circuitry 255b may process the TIEs of the access set to determine which cache line(s) (if any) is in a modified state. In another example, control circuitry 255b may process the TIEs of the access set to determine which cache line (if any) is in a modified state and associated with the current access set. In an embodiment, in addition to determining which cache line is in a modified state, control circuitry 255b may also consider, particularly when more than one cache line is in a modified state, which modified cache line associated with the current access set is the least recently used cache line of the access set. Based on control circuitry 255b determining that at least one cache line associated with the current access set is in a modified state, an indicator of the modified state is transmitted via HM interface 213. This is illustrated in FIG. 2C by arrow 292b running from tag compare circuitry 252b to HM interface 213. In an embodiment, based on control circuitry 255b determining that at least one cache line associated with the current access set is in a modified state, HM interface 213 may also transmit an indicator of which cache line(s) (e.g., tag value or tag values) are in a modified state.

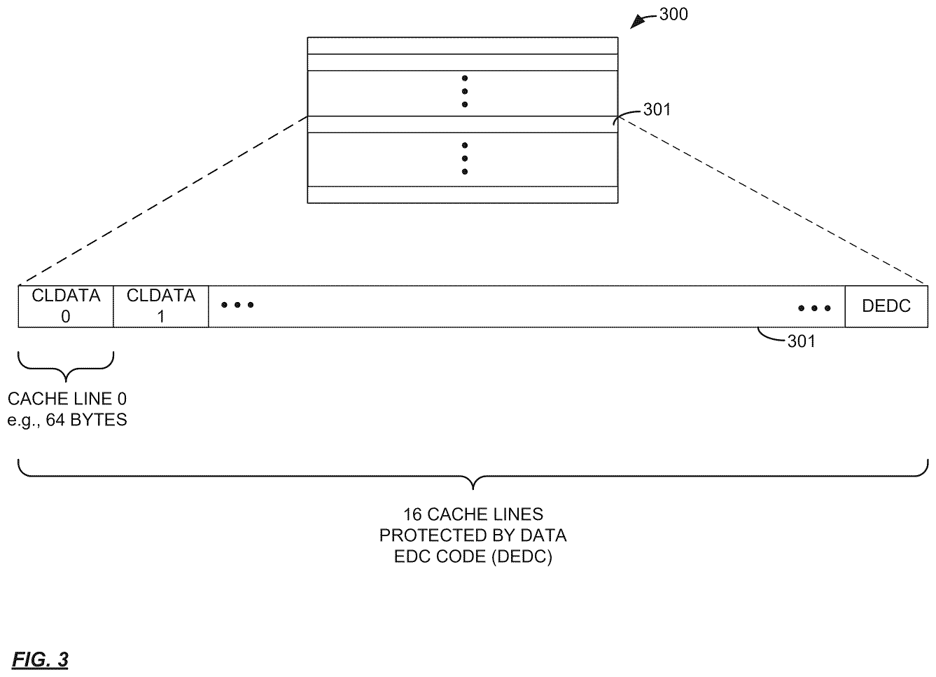

FIG. 3 is a diagram illustrating an example placement of cache line data in a row of DRAM bank. In FIG. 3, the data placement of cache line data and data EDC information into the rows of a memory bank 300 (e.g., each of memory banks 140) is illustrated. In particular, the example data placement into row 301 of memory bank 300 is illustrated. In FIG. 3, the cache lines stored in row 301 is illustrated starting at the leftmost position in row 301 with the data for cache line 0 (CLDATA0). To the right of cache line 0 is the data for cache line 1 (CLDATA1), and so on. To the right of the cache line data stored in row 301, is the data EDC information (DEDC). The data EDC information is illustrated in the rightmost locations of row 301. In another embodiment, rather than having each cache line completely contained in a single bank, cache lines may be split across multiple memory banks 140 and the multiple memory banks 140 operated together to access entire cache lines (and data EDC information). Thus, in this embodiment, the amount of a cache line stored in each row may be adjusted appropriately (e.g., 4 bytes of cache line data per row, per each bank of 16 banks).

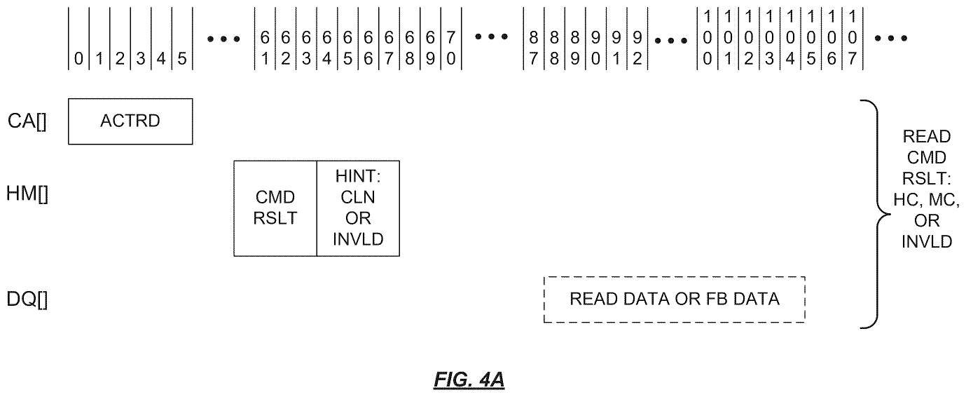

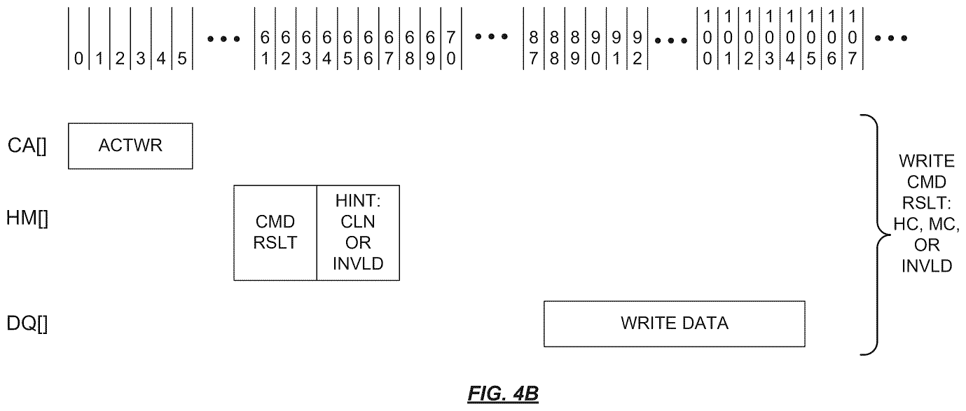

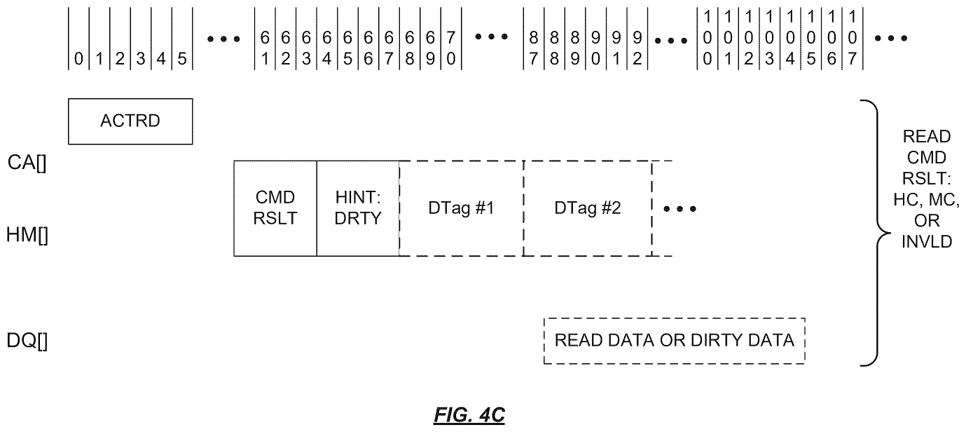

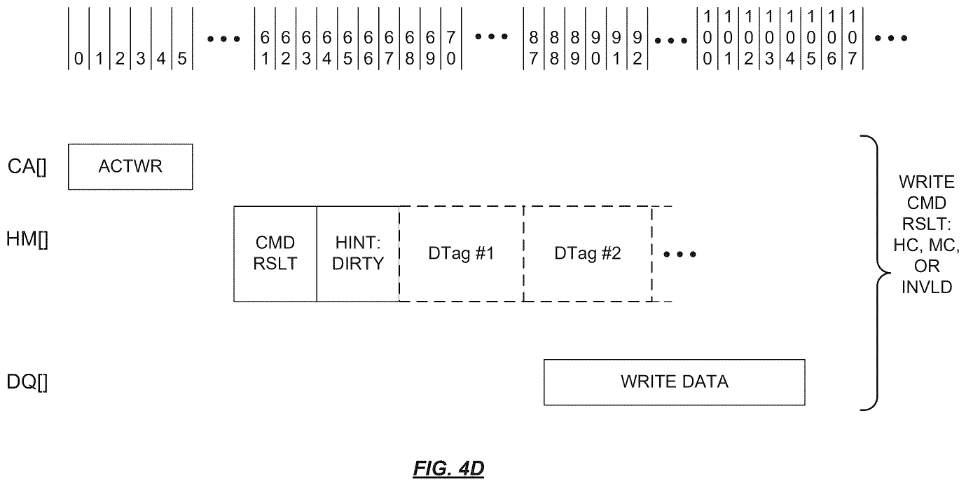

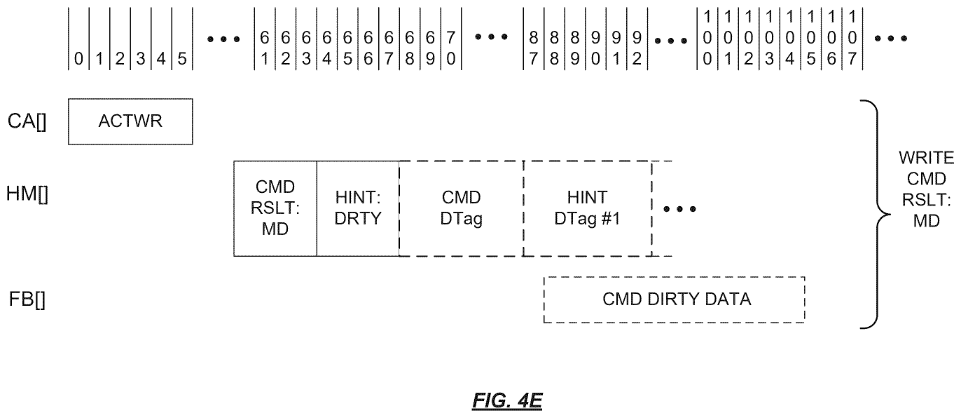

FIGS. 4A-4E illustrate example bus communications for cache access operations. FIG. 4A illustrates example bus communications where the result of the tag compare and cache line status for an ACTRD command was a one of: a “hit” where the subject cache line is in an unmodified state (a.k.a. “hit clean”—HC); a “miss” where the cache line occupying the location where the subject cache line would have been, if it were present, is in an unmodified state (a.k.a., a “miss clean”—MC); or the location where the subject cache line would have been, if it were present, is in an invalid state (a.k.a., “invalid”—INVLD) and the results from the access set indicate that either all of the cache lines associated with the access set TIEs are in a clean state (CLN) or all are in an invalid state (INVLD). Thus, in FIG. 4A, the HM[] bus is illustrated indicating the result of the ACTRD command, which is a one of HC, MC, or INVLD, followed by a “hint” indicating either a CLN or INVLD state. Based on the HC, MC, or INVLD state of the subject cache line, and further based on the CLN or INVLD state of the access set cache lines, the data (DQ) bus communicates either the requested cache line (for the HC result), or may optionally, depending on a mode (e.g., indicated by mode registers 156) or other indicator (e.g., command bit, configuration, etc.), communicate a cache line from a buffer (e.g., flush buffer 147).

FIG. 4B illustrates example bus communications where the result of the tag compare and cache line status for an ACTWR command was a one of: a “hit” where the subject cache line is present and is in an unmodified state (a.k.a. “hit clean”—HC); a “miss” where the location where the subject cache line is to be written does not already contain the subject cache line and the cache line occupying that location is in an unmodified state (a.k.a., a “miss clean”—MC); or the location where the subject cache line is to be written is in an invalid state (a.k.a., “invalid”—INVLD) and the results from the access set indicate that either all of the cache lines associated with the access set TIEs are in a clean state (CLN) or all are in an invalid state (INVLD). Thus, in FIG. 4B, the HM[] bus is illustrated indicating the result of the ACTWR command, which is a one of HC, MC, or INVLD, followed by a “hint” indicating either a CLN or INVLD state. In FIG. 4B, the data (DQ) bus communicates the cache line to be written.

FIG. 4C illustrates example bus communications where the result of the tag compare and cache line status for an ACTRD command was one of a HC, MC, or INVLD and the results from the access set indicate that at least one of the cache lines associated with the access set TIEs is valid and in a modified state (a.k.a., “dirty”—DRTY). Thus, in FIG. 4C, the HM[] bus is illustrated indicating the result of the ACTRD command, which is one of HC, MC, or INVLD, followed by a “hint” indicating a DRTY state. Based on the HC, MC, INVLD state of the subject cache line, and further based on the DRTY state of the at least one access set cache line, the HM bus communicates the tag value associated with at least one of the “dirty” cache line(s) of the access set. The maximum number of dirty tag values that may be communicated may be determined by, for example, a mode or other indicator (e.g., command bit, configuration, etc.) Based on the HC state of the subject cache line, the data (DQ) bus communicates the requested cache line. Based on a MC or INVLD result, the DQ bus may, depending on a mode (e.g., indicated by mode registers 156) or other indicator (e.g., command bit, configuration, etc.), communicate dirty data associated with at least one of the cache lines in the access set that is dirty. In an embodiment, based on a MC or INVLD result, the DQ bus may, depending on a mode (e.g., indicated by mode registers 156) or other indicator (e.g., command bit, configuration, etc.), send dirty data associated with a cache line not in the access set from a flush buffer (when present) and place dirty data associated with at least one of the cache lines in the access set that is dirty into the flush buffer. The maximum number of dirty cache lines that may be communicated (or placed into the flush buffer) may be determined by, for example, a mode (e.g., indicated by mode registers 156) or other indicator (e.g., command bit, configuration, etc.).

FIG. 4D illustrates example bus communications where the result of the tag compare and cache line status for an ACTWR command was one of a HC, MC, or INVLD and the results from the access set indicate that at least one the cache lines associated with the access set TIEs is valid and in a modified state (a.k.a., “dirty”—DRTY). Thus, in FIG. 4D, the HM[] bus is illustrated indicating the result of the ACTWR command, which is a one of HC, MC, or INVLD, followed by a “hint” indicating a DRTY state. Based on the HC, MC, INVLD state of the subject cache line, and further based on the DRTY state of the at least one access set cache line, the HM bus communicates the tag value associated with at least one of the “dirty” cache line(s) of the access set. The maximum number of dirty tag values that may be communicated may be determined by, for example, a mode (e.g., indicated by mode registers 156) or other indicator (e.g., command bit, configuration, etc.) In FIG. 4D, the data (DQ) bus communicates the cache line to be written.

FIG. 4E illustrates example bus communications where the result of the tag compare and cache line status for an ACTWR command indicates the location where the subject cache line is to be written does not already contain the subject cache line and the cache line occupying that location is in a valid and modified state (a.k.a., a “miss dirty”—MD) and the results from the access set indicate that at least one the cache lines associated with the access set TIEs is valid and also in a modified state. Thus, in FIG. 4E, the HM[] bus is illustrated indicating the result of the ACTWR command, which is a MD, followed by a “hint” indicating a DRTY state. Based on the MD state of the subject cache line, and further based on the DRTY state of the at least one access set cache line, the HM bus may optionally communicate (e.g., based on a mode, etc.) a first tag value associated with the dirty cache line occupying the location where the subject cache line is to be written, and also may optionally communicate (e.g., based on a mode, etc.) a second (or third, etc.) tag value associated with the cache lines in the access set that are dirty. The maximum number of dirty tag values from the access set that may be communicated may be determined by, for example, a mode (e.g., indicated by mode registers 156) or other indicator (e.g., command bit, configuration, etc.) In FIG. 4E, the dirty cache line data occupying the location where the subject cache line is to be written may be optionally stored in a flush buffer (e.g., buffer 147) for later communication to a controller.

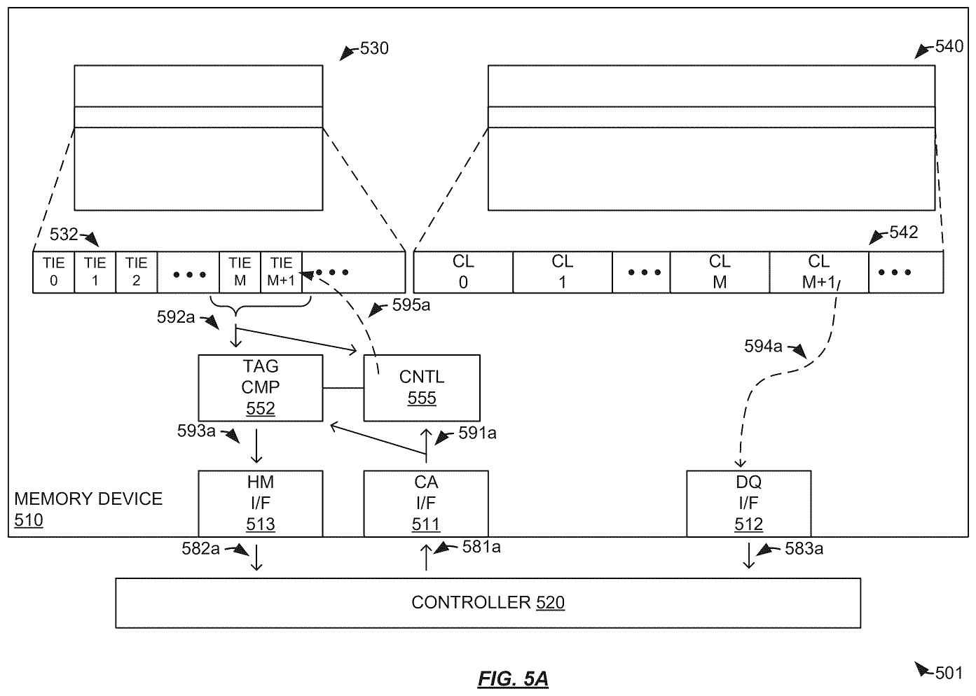

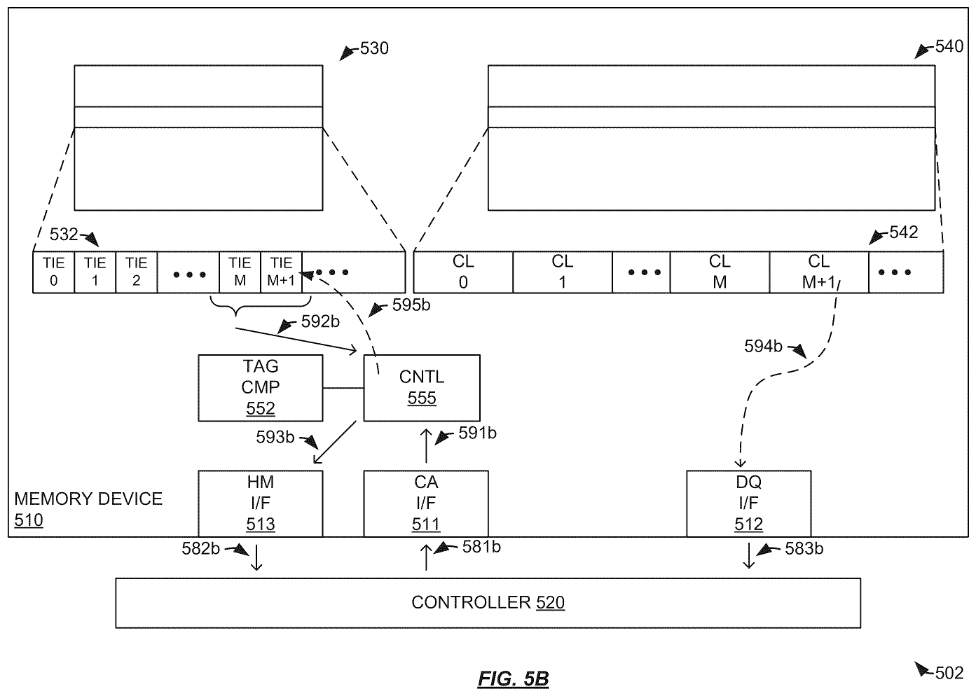

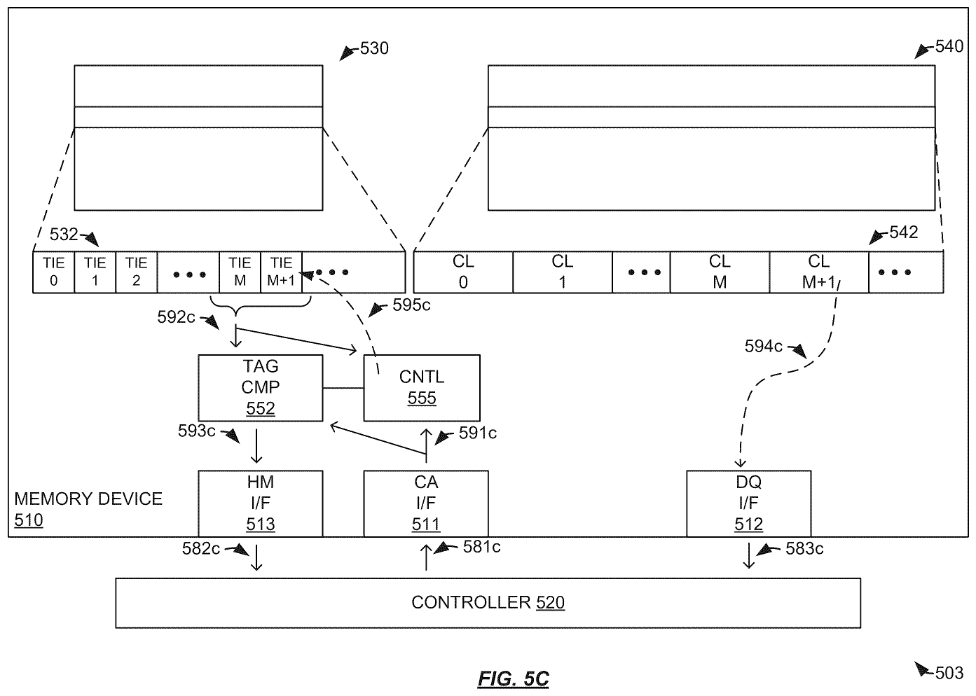

FIGS. 5A-5C are diagrams illustrating example cache cleaning commands/operations. FIG. 5A illustrates a memory system 501 performing a first example cache cleaning operation where, if a modified and valid cache line is present in the associated access set and was not the addressed cache line (i.e., a miss), the modified data is transmitted to the controller and the modified state indicator for the transmitted cache line is cleared to indicate an unmodified state. The command to perform these operations may be referred to as a “read-if-miss-dirty” command.

In FIG. 5A, controller 520 transmits, to memory device 510 and via command/address interface 511, a read-if-miss-dirty command, associated address, and associated tag query value. This is illustrated in FIG. 5A by arrow 581a. The associated address and associated tag query value may be, for example, the address and tag value associated with a write command that controller 520 is preparing to transmit (e.g., has queued for later transmission). The read-if-miss-dirty command is received by control circuitry 555 and at least the tag query value is received by tag compare circuitry 552. This is illustrated in FIG. 5A by arrows 591a. Based on the read-if-miss-dirty command, memory banks 530 and memory banks 540 read the addressed rows into column circuitry 532 and column circuitry 542, respectively. This is illustrated in FIG. 5A by column circuitry 532 holding tag information entries (e.g., TIE 0, TIE 1, . . . TIE M, TIE M+1, . . .) and column circuitry 542 holding cache lines (e.g., CL 0, CL 1, . . . CL M, CL M+1, . . . ).

All or portions of the addressed access set are provided to tag compare circuitry 552 and control circuitry 555. This is illustrated in FIG. 5A by arrows 592a. Tag compare circuitry 552 and control circuitry 555 determine whether one or more cache lines in the access set were a miss, modified, and valid. If only one cache line in the access set was a miss, modified, and valid, that cache line may be selected for transmission to controller 520. If more than one line in the access set were misses, modified, and valid, in an embodiment, one (or more) of those cache line may be selected for transmission to controller 520 based on recency indicators (e.g., which of those cache lines was least recently used based on LRU metadata) associated with those cache lines. If all cache lines in the access set were misses, and at least one of the cache lines in the access set is modified and valid, one or more of the associated tags and data may be selected for transmission to controller 520. If a cache line in the access set was a hit, and at least one other cache line in the access set was a miss, modified, and valid, a “hit” result may be indicated and an indicator of the dirty cache line(s) and dirty cache line data (for one or more dirty cache lines) may optionally be selected for transmission to controller 520.

An indicator of the result of the read-if-miss-dirty command is transmitted to controller 520. For example, an indicator of whether a cache line that was a miss, modified, and valid was found may be transmitted to controller 520 via HM interface 513. This is illustrated in FIG. 5A by arrow 593a and arrow 582a. In an embodiment, an indicator of which dirty cache line was selected for transmission may also be transmitted to controller 520 via HM interface 513. Based on a cache line that was a miss, modified, and valid being found by tag compare circuitry 552 and/or control circuitry 555, memory device 510 transmits that modified and valid cache line to controller 520 via DQ interface 512. This is illustrated in FIG. 5A by arrows 594a and 583a. Based on memory device 510 transmitting the selected modified and valid cache line to controller 520, memory device 510 clears the modified indicator associated with the transmitted cache line and writes the TIE indicating an unmodified state associated with that cache line back to memory bank 530. This is illustrated in FIG. 5A by arrow 595a.

FIG. 5B illustrates a memory system 502 performing a second example cache cleaning operation where, if a modified and valid cache line is present in the associated access set, the modified data is transmitted to the controller and the modified state indicator for the transmitted cache line is cleared to indicate an unmodified state. The command to perform these operations may be referred to as a “read-if-dirty” command.

In FIG. 5B, controller 520 transmits, to memory device 510 and via command/address interface 511, a read-if-dirty command and associated address. This is illustrated in FIG. 5B by arrow 581b. The associated address may be, for example, the address associated with a write to a set in a set associative configured cache that controller 520 is preparing to transmit (e.g., has queued for later transmission and writing to that set). The associated address may be, in another example, an address corresponding to a previously transmitted hint (e.g., as a result of a command that did not result in the tag information associated with that address being transmitted). The read-if-dirty command is received by control circuitry 555. This is illustrated in FIG. 5B by arrow 591b. Based on the read-if-dirty command, memory banks 530 and memory banks 540 read the addressed rows into column circuitry 532 and column circuitry 542, respectively. This is illustrated in FIG. 5B by column circuitry 532 holding tag information entries (e.g., TIE 0, TIE 1, . . . TIE M, TIE M+1, . . . ) and column circuitry 542 holding cache lines (e.g., CL 0, CL 1, . . . CL M, CL M+1, . . . ).

All or portions of the addressed access set are provided to control circuitry 555. This is illustrated in FIG. 5B by arrow 592b. Control circuitry 555 determines whether one or more cache lines in the access set were modified and valid. If one cache line in the access set was modified, and valid, that cache line is selected for transmission to controller 520. If more than one line in the access set were in a modified and valid state, one (or more) of those cache lines is selected for transmission to controller 520 based on recency indicators (e.g., which of those cache lines was least recently used based on LRU metadata) associated with those cache lines.

An indicator of the result of the read-if-dirty command is transmitted to controller 520. For example, an indicator of whether a cache line in the access set that was modified and valid was found may be transmitted to controller 520 via HM interface 513. This is illustrated in FIG. 5B by arrow 593b and arrow 582b. An indicator of which dirty cache line was selected for transmission may also be transmitted to controller 520 via HM interface 513. Based on a cache line that was modified and valid being found by control circuitry 555, memory device 510 transmits that modified and valid cache line to controller 520 via DQ interface 512. This is illustrated in FIG. 5B by arrows 594b and 583b. Based on memory device 510 transmitting the selected modified and valid cache line to controller 520, memory device 510 clears the modified indicator associated with the transmitted cache line and writes the TIE indicating an unmodified state associated with that cache line back to memory bank 530. This is illustrated in FIG. 5B by arrow 595b.

FIG. 5C illustrates a memory system 503 performing a third example cache cleaning operation where, if an addressed cache line is present (i.e., hit), modified, and valid, the modified data is transmitted to the controller and the modified state indicator for the transmitted cache line is cleared to indicate an unmodified state. The command to perform these operations may be referred to as a “read-and-clean” command.

In FIG. 5C, controller 520 transmits, to memory device 510 and via command/address interface 511, a read-and-clean command, associated address, and associated tag query value. This is illustrated in FIG. 5C by arrow 581c. The associated address and associated tag query value may be, for example, the address and tag value associated with a write command that controller 520 is preparing to transmit (e.g., has queued for later transmission). The associated address may be, in another example, an address corresponding to a previously transmitted hint (e.g., as a result of a command that resulted in the tag information associated with that address being transmitted). The read-and-clean command is received by control circuitry 555 and at least the tag query value is received by tag compare circuitry 552. This is illustrated in FIG. 5C by arrows 591c. Based on the read-and-clean command, memory banks 530 and memory banks 540 read the addressed rows into column circuitry 532 and column circuitry 542, respectively. This is illustrated in FIG. 5C by column circuitry 532 holding tag information entries (e.g., TIE 0, TIE 1, . . . TIE M, TIE M+1, . . . ) and column circuitry 542 holding cache lines (e.g., CL 0, CL 1, . . . CL M, CL M+1, . . . ).

All or portions of the addressed access set are provided to tag compare circuitry 552 and control circuitry 555. This is illustrated in FIG. 5C by arrows 592c. Tag compare circuitry 552 and control circuitry 555 determine whether one of the cache lines in the access set were a hit, modified, and valid. If a cache line in the access set was a hit, modified, and valid, that cache line is selected for transmission to controller 520.

An indicator of the result of the read-and-clean command is transmitted to controller 520. For example, an indicator of whether a cache line that was a hit, modified, and valid was found may be transmitted to controller 520 via HM interface 513. This is illustrated in FIG. 5C by arrow 593c and arrow 582c. Based on a cache line that was a hit, modified, and valid being found by tag compare circuitry 552 and/or control circuitry 555, memory device 510 transmits that modified and valid cache line to controller 520 via DQ interface 512. This is illustrated in FIG. 5C by arrows 594c and 583c. Based on memory device 510 transmitting the selected modified and valid cache line to controller 520, memory device 510 clears the modified indicator associated with the transmitted cache line and writes the TIE indicating an unmodified state associated with that cache line back to memory bank 530. This is illustrated in FIG. 5C by arrow 595c.

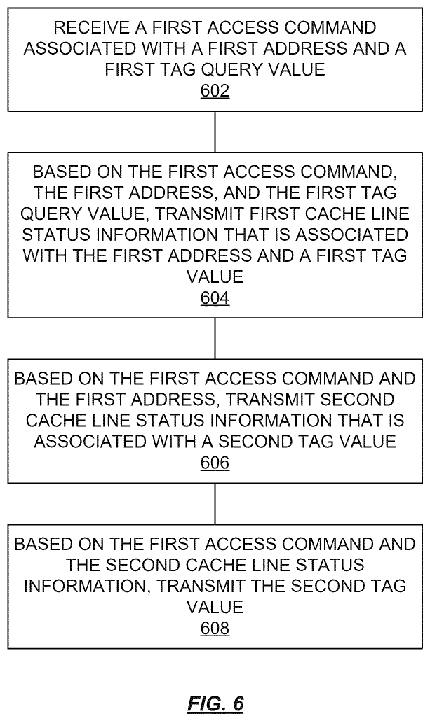

FIG. 6 is a flowchart illustrating an example method of providing cache line status hints. One or more steps illustrated in FIG. 6 may be performed by, for example, memory system 100, memory systems 501-503, and/or their components. A first access command associated with a first address and a first tag query value is received (602). For example, memory device 110 may receive, from controller 120, an ACTRD or ACTWR command in association with an address and a tag query value.

Based on the first access command, the first address, and the first tag query value, first cache line status information that is associated with the first address and a first tag value is transmitted (604). For example, based on the ACTRD (or ACTWR) command, memory device 110 may transmit, to memory controller 120, indicators of whether the address and tag query value associated with the ACTRD (or ACTWR) command matched a tag value of a valid cache line in the access set (i.e., a hit—the addressed cache line is present and valid), or did not match a tag value of a valid cache line in the access set (i.e., a miss—the addressed cache line is not present and/or is not valid).

Based on the first access command and the first address, second cache line status is transmitted that is associated with a second tag value (606). For example, based on the ACTRD (or ACTWR) command, memory device 110 may further transmit, to memory controller 120, an indicator of whether a valid and modified cache line in the access set is that is associated with a tag value that did not match the tag query value has been found. Based on the first access command and the second cache line status information, the second tag value is transmitted (608). For example, based on the ACTRD (or ACTWR) command and the finding of a valid and modified cache line in the access set is that is associated with a tag value that did not match the tag query value, memory device 110 may further transmit, to memory controller 120, the tag value that did not match the tag query value and is associated with a valid and modified cache line.

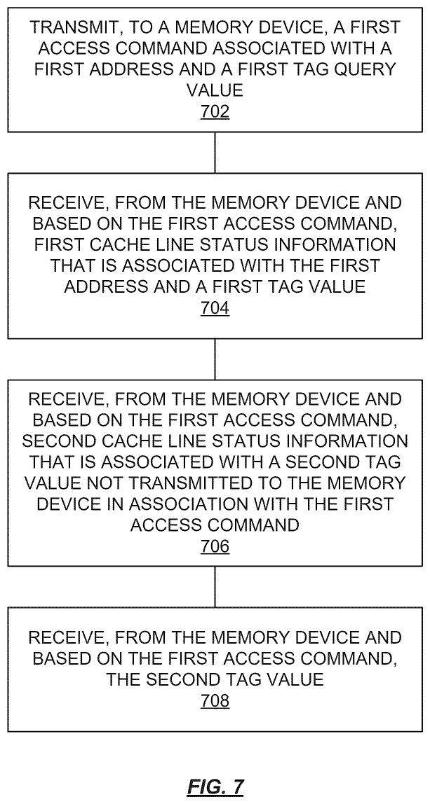

FIG. 7 is a flowchart illustrating an example method of receiving cache line status hints. One or more steps illustrated in FIG. 7 may be performed by, for example, memory system 100, memory systems 501-503, and/or their components. To a memory device, a first access command associated with a first address and a first tag query value is transmitted (602). For example, controller 120 may transmit, to memory device 110 an ACTRD or ACTWR command in association with an address and a tag query value.

From the memory device and based on the first access command, first cache line status information that is associated with the first address and a first tag value is received (704). For example, based on the ACTRD (or ACTWR) command, memory controller 120 may receive, from memory device 110, indicators of whether the tag query value associated with the ACTRD (or ACTWR) command matched a tag value of a valid cache line in the access set (i.e., a hit—the addressed cache line is present and valid), or did not match a tag value of a valid cache line in the access set (i.e., a miss—the addressed cache line is not present and/or is not valid).

From the memory device and based on the first access command, second cache line status that is associated with a second tag value not transmitted to the memory device in association with the first command is received (706). For example, based on the ACTRD (or ACTWR) command, memory controller 120 may receive, from memory device 110, an indicator that a valid and modified cache line in the access set that is associated with a tag value that did not match the tag query value has been found. From the memory device and based on the first access command, the second tag value is received (708). For example, based on the ACTRD (or ACTWR) command and the finding of a valid and modified cache line in the access set is that is associated with a tag value that did not match the tag query value, memory controller 120 may receive, from memory device 110, the tag value that did not match the tag query value.

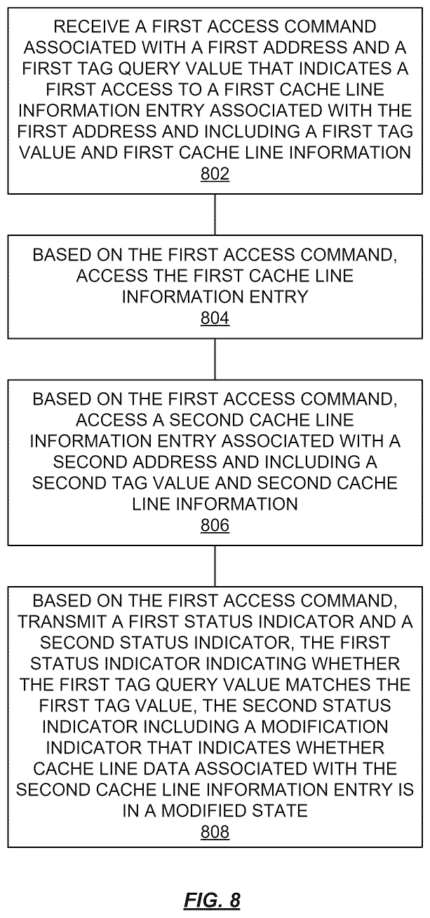

FIG. 8 is a flowchart illustrating an example method of providing multiple cache line status indicators. One or more steps illustrated in FIG. 8 may be performed by, for example, memory system 100, memory systems 501-503, and/or their components. A first access command associated with a first address and a first tag query value that indicates a first access to a first cache line information entry associated with the first address and including a first tag value and first cache line information is received (802). For example, memory device 110 may receive, from controller 120, an ACTRD (or ACTWR) command associated with a first address and a first tag query value that is to result in memory device 110 reading, into column circuitry 132 from memory bank 130, an access set of a plurality of tag information entries, where the access set includes a first tag information entry having a first tag value and first metadata and is associated with a first cache line that is stored by memory bank 140.

Based on the first access command, the first cache line information entry is accessed (804). For example, in response to the ACTRD (or ACTWR) memory device 110 may read the first tag information entry from column circuitry 132. Based on the first access command, a second cache line information entry associated with a second address and including a second tag value and second cache line information is accessed (806). For example, memory device 110 may read a second cache line information entry that includes a second tag value and second metadata from column circuitry 132, where the second tag value does not match the first tag query value.

Based on the first access command, a first status indicator and a second status indicator are transmitted, where the first status indicator indicates whether the first tag query value matches the first tag value, and the second status indicator includes a modification indicator that indicates whether cache line data associated with the second cache line information entry is in a modified state (808). For example, memory device 110 may transmit, via HM interface 113, a first indicator of whether the first tag value from the first tag information entry matches the first tag value and also transmit, via HM interface 113, a second indicator of whether the second cache line information entry indicates the cache line associated with the second cache line information entry is in a modified state.

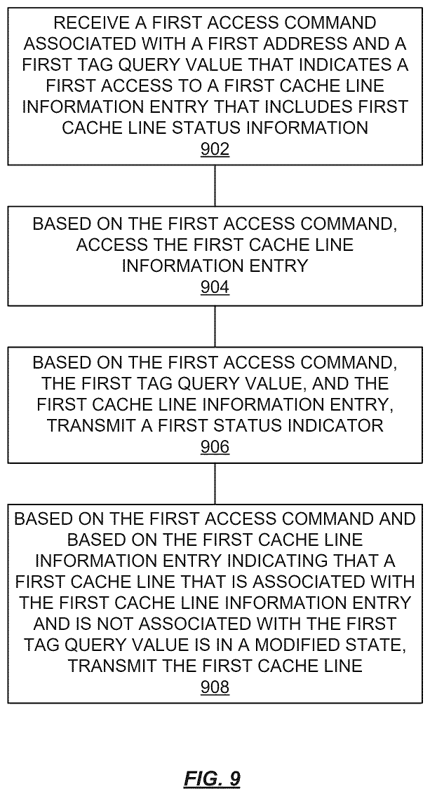

FIG. 9 is a flowchart illustrating a first example method of transmitting a modified cache line. One or more steps illustrated in FIG. 9 may be performed by, for example, memory system 100, memory systems 501-503, and/or their components. A first access command associated with a first address and a first tag query value that indicates a first access to a first cache line information entry that includes first cache line status information is received (902). For example, memory device 110 may receive, from controller 120, a read-if-miss-dirty command, associated with a first tag query value, that is directed (addressed) to a first access set of tag information entries that include a first tag information entry.

Based on the first access command, access the first cache line information entry (904). For example, memory device 110 may, based on the received read-if-miss-dirty command, read a row into column circuitry 132 and provide the tag information entries of the first access set to tag compare circuitry 152 and control circuitry 155. Based on the first access command, the first tag query value, and the first cache line information entry, a first status indicator is transmitted (906). For example, memory device 110 may transmit, via HM interface 113, an indicator of whether at least one cache line in the access set was a miss, modified, and valid. Memory device 110 may, in some embodiments, also transmit, via HM interface 113, an indicator of whether the first tag query value resulted in a hit or a miss. In these embodiments, if the first tag query value resulted in a hit, memory device 110 may also transmit, via HM interface 113, an indicator that another line was a miss, modified, and valid. If the first tag query value resulted in a hit, memory device 110 may also transmit, via HM interface 113, an indicator of the line (e.g., way indicator, or tag value) that was a miss, modified, and valid.

Based on the first access command and based on the first cache line information entry indicating that a first cache line associated with the first cache line information entry and is not associated with the first tag query value is in a modified state, the first cache line is transmitted (908). For example, based on the first tag information entry having a tag value that does not match the first tag query value and the first tag information entry indicating the cache line associated with the first tag information entry is valid and in a modified state, memory device 110 may transmit, to controller 120, the cache line associated with the first tag information entry.

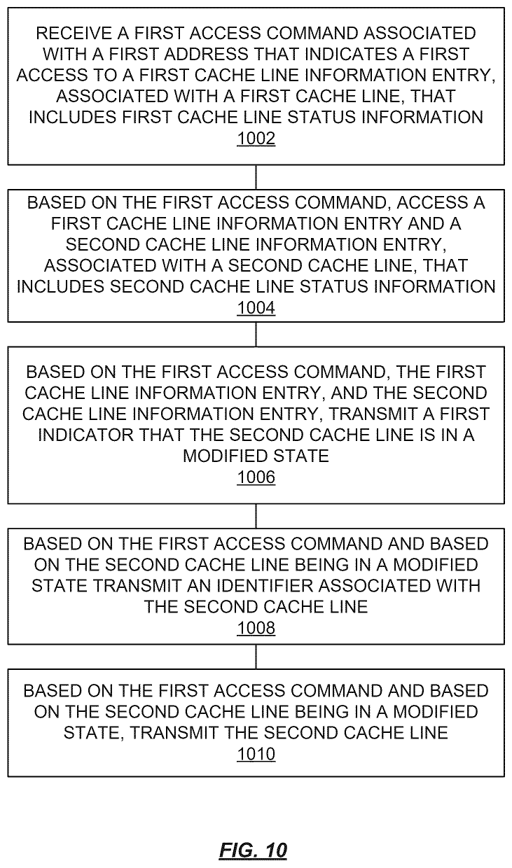

FIG. 10 is a flowchart illustrating a second example method of transmitting a modified cache line. One or more steps illustrated in FIG. 10 may be performed by, for example, memory system 100, memory systems 501-503, and/or their components. A first access command associated with a first address that indicates a first access to a first cache line information entry, associated with a first cache line, that includes first cache line status information is received (1002). For example, memory device 110 may receive, from controller 120, a read-if-dirty command that is directed (addressed) to a first access set of tag information entries that include a first tag information entry.

Based on the first access command, the first cache line information entry and a second cache line information entry, associated with a second cache line, are accessed, where the second cache line information entry includes second cache line status information (1004). For example, memory device 110 may, based on the received read-if-dirty command, read a row into column circuitry 132 and provide the first tag information entry and a second tag information entry of the first access set to control circuitry 155. Based on the first access command, the first cache line information entry and the second cache line information entry, a first indicator that the second cache line is in a modified state is transmitted (1006). For example, memory device 110 may transmit, to controller 120, and indicator that memory device 110 has determined that a cache line associated with the second tag information entry is valid and in a modified state.

Based on the first access command and based on the second cache line being in a modified state, an identifier associated with the second cache line is transmitted (1008). For example, based on memory device 110 determining that a cache line associated with the second tag information entry is valid and in a modified state, memory device 110 may transmit the tag value from the second tag information entry to controller 120. Based on the first access command and based on the second cache line being in a modified state, the second cache line is transmitted (1010). For example, based on memory device 110 determining that the cache line associated with the second tag information entry is valid and in a modified state, memory device 110 may transmit the cache line associated with the second tag information entry to controller 120.

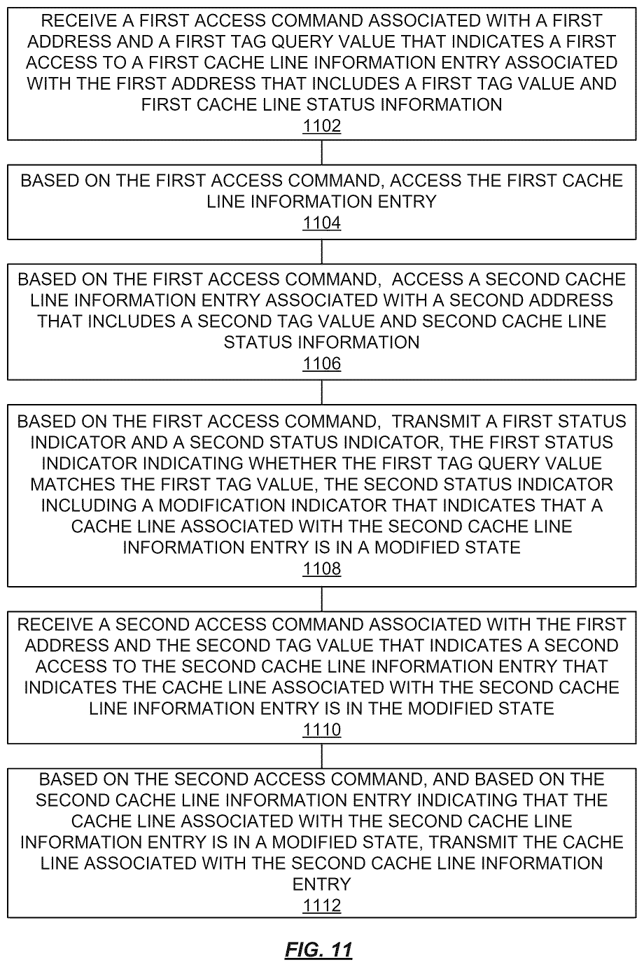

FIG. 11 is a flowchart illustrating a third example method of transmitting a modified cache line. One or more steps illustrated in FIG. 11 may be performed by, for example, memory system 100, memory systems 501-503, and/or their components. A first access command associated with a first address and a first tag query value that indicates a first access to a first cache line information entry associated with the first address that includes a first tag value and first cache line status information is received (1102). For example, memory device 110 may receive, from controller 120, an ACTRD (or ACTWR) command in association with an address and a tag query value that is to result in memory device 110 reading an access set of tag information entries, from column circuitry 132, that include a first tag information entry and a second tag information entry.

Based on the first access command, the first cache line information entry is accessed (1104). For example, based on the ACTRD (or ACTWR), memory device 110 may provide the first tag information entry to tag compare circuitry 152 and control circuitry 155. Based on the first access command, a second cache line information entry associated with a second address that include a second tag value and second cache line status is accessed (1106) For example, based on the ACTRD (or ACTWR), memory device 110 may provide the second tag information entry to control circuitry 155, where the tag value in the second tag information entry does not match the tag query value associated with the command.

Based on the first access command, a first status indicator and a second status indicator are transmitted, where the first status indicator indicates whether the first tag query value matched the first tag value, and the second status indicator includes a modification indicator that indicates that a cache line associated with the second cache line information entry is in a modified state (1108). For example, based on the ACTRD (or ACTWR) command, memory device 110 may transmit, to controller 120, a hit/miss indicator that is based on a compare of the tag query value and the tag value in the first tag information entry, and may further transmit, an indicator that the cache line associated with the second tag information entry has been modified.

A second access command associated with the first address and the second tag value that indicates a second access to the second cache line information entry that indicates the cache line associated with the second cache line information entry is in the modified state is received (1110). For example, memory device 110 may receive, from memory controller 120, a read-and-clean command directed to the cache line associated with the second tag information entry. Based on the second access command, and based on the second cache line information entry indicating that the cache line associated with the second cache line information entry is in a modified state, transmit the cache line associated with the second cache line information entry (1112). For example, based on the read-and-clean command, and the second tag information entry indicating the cache line associated with the second tag information entry is in a modified state, memory device 110 may transmit the cache line associated with the second tag information entry to controller 120.

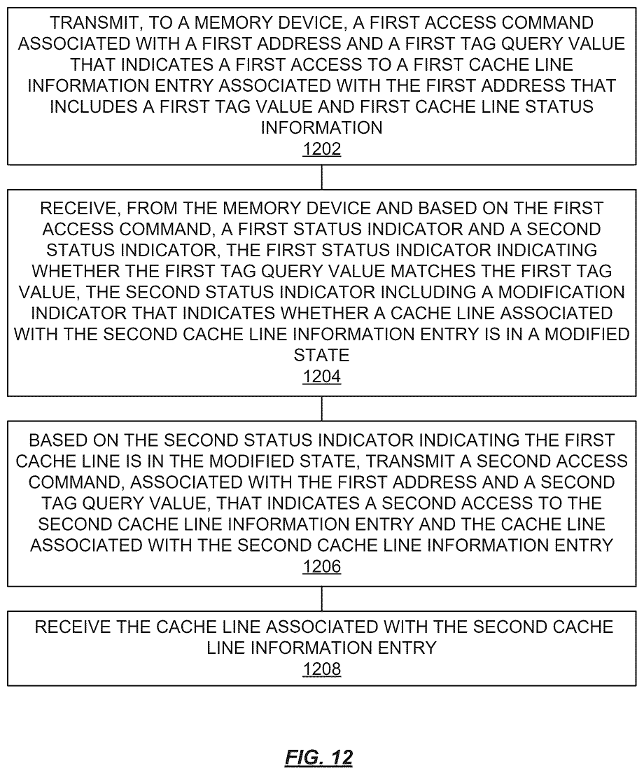

FIG. 12 is a flowchart illustrating an example method of cleaning a modified cache line. One or more steps illustrated in FIG. 12 may be performed by, for example, memory system 100, memory systems 501-503, and/or their components. A first access command associated with a first address and a first tag query value that indicates a first access to a first cache line information entry associated with the first address that includes a first tag value and first cache line status information is transmitted (1102). For example, controller 120 may transmit, to memory device 110, an ACTRD (or ACTWR) command in association with an address and a tag query value that is to result in memory device 110 reading an access set of tag information entries, from column circuitry 132, that include a first tag information entry and a second tag information entry.

From the memory device and based on the first access command, a first status indicator and a second status indicator are received, where the first status indicator indicates whether the first tag query value match the first tag value, and the second status indicator includes a modification indicator that indicates that a cache line associated with the second cache line information entry is in a modified state (1204). For example, based on the ACTRD (or ACTWR) command, controller 120 may receive, from memory device 110, a hit/miss indicator that is based on a compare of the tag query value and the tag value in the first tag information entry, and may further transmit, an indicator that the cache line associated with the second tag information entry has been modified.

Based on the second status indicator indicating that the cache line associated with the second cache line information entry is in the modified state, a second access command, associated with the first address and a second tag query value, that indicates a second access to the second cache line information entry and the cache line associated with the second cache line information entry (1206). For example, memory controller 120 may transmit, to memory device 110, a read-and-clean command directed to the cache line associated with the second tag information entry. Receive the cache line associated with the second cache line information entry (1208). For example, based on the read-and-clean command, memory device 110 may transmit the cache line associated with the second tag information entry to controller 120.

The methods, systems and devices described above may be implemented in computer systems, or stored by computer systems. The methods described above may also be stored on a non-transitory computer readable medium. Devices, circuits, and systems described herein may be implemented using computer-aided design tools available in the art, and embodied by computer-readable files containing software descriptions of such circuits. This includes, but is not limited to one or more elements of memory system 100, memory systems 501-503, and their components. These software descriptions may be: behavioral, register transfer, logic component, transistor, and layout geometry-level descriptions. Moreover, the software descriptions may be stored on storage media or communicated by carrier waves.

Data formats in which such descriptions may be implemented include, but are not limited to: formats supporting behavioral languages like C, formats supporting register transfer level (RTL) languages like Verilog and VHDL, formats supporting geometry description languages (such as GDSII, GDSIII, GDSIV, CIF, and MEBES), and other suitable formats and languages. Moreover, data transfers of such files on machine-readable media may be done electronically over the diverse media on the Internet or, for example, via email. Note that physical files may be implemented on machine-readable media such as: 4 mm magnetic tape, 8 mm magnetic tape, 3-½ inch floppy media, CDs, DVDs, and so on.

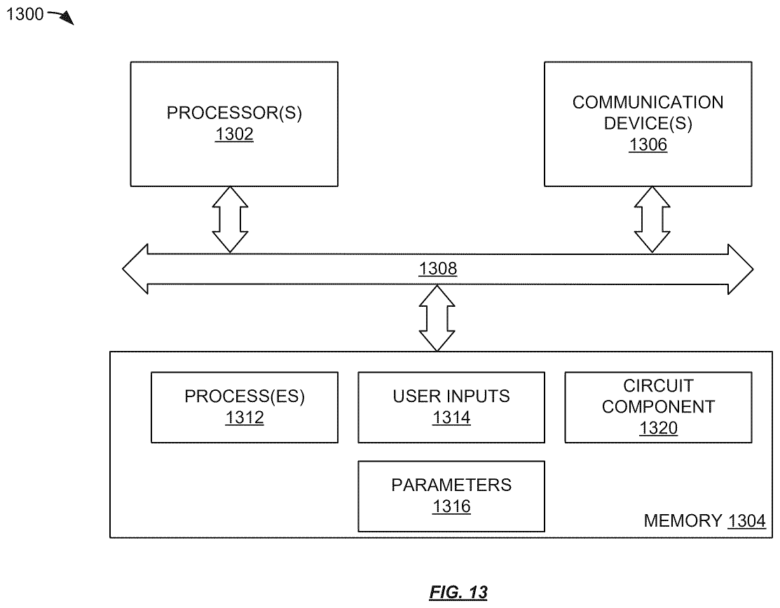

FIG. 13 is a block diagram illustrating one embodiment of a processing system 1300 for including, processing, or generating, a representation of a circuit component 1320. Processing system 1300 includes one or more processors 1302, a memory 1304, and one or more communications devices 1306. Processors 1302, memory 1304, and communications devices 1306 communicate using any suitable type, number, and/or configuration of wired and/or wireless connections 1308.

Processors 1302 execute instructions of one or more processes 1312 stored in a memory 1304 to process and/or generate circuit component 1320 responsive to user inputs 1314 and parameters 1316. Processes 1312 may be any suitable electronic design automation (EDA) tool or portion thereof used to design, simulate, analyze, and/or verify electronic circuitry and/or generate photomasks for electronic circuitry. Representation 1320 includes data that describes all or portions of memory system 100, memory systems 501-503, and their components, as shown in the Figures.

Representation 1320 may include one or more of behavioral, register transfer, logic component, transistor, and layout geometry-level descriptions. Moreover, representation 1320 may be stored on storage media or communicated by carrier waves.

Data formats in which representation 1320 may be implemented include, but are not limited to: formats supporting behavioral languages like C, formats supporting register transfer level (RTL) languages like Verilog and VHDL, formats supporting geometry description languages (such as GDSII, GDSIII, GDSIV, CIF, and MEBES), and other suitable formats and languages. Moreover, data transfers of such files on machine-readable media may be done electronically over the diverse media on the Internet or, for example, via email.

User inputs 1314 may comprise input parameters from a keyboard, mouse, voice recognition interface, microphone and speakers, graphical display, touch screen, or other type of user interface device. This user interface may be distributed among multiple interface devices. Parameters 1316 may include specifications and/or characteristics that are input to help define representation 1320. For example, parameters 1316 may include information that defines device types (e.g., NFET, PFET, etc.), topology (e.g., block diagrams, circuit descriptions, schematics, etc.), and/or device descriptions (e.g., device properties, device dimensions, power supply voltages, simulation temperatures, simulation models, etc.).

Memory 1304 includes any suitable type, number, and/or configuration of non-transitory computer-readable storage media that stores processes 1312, user inputs 1314, parameters 1316, and circuit component 1320.

Communications devices 1306 include any suitable type, number, and/or configuration of wired and/or wireless devices that transmit information from processing system 1300 to another processing or storage system (not shown) and/or receive information from another processing or storage system (not shown). For example, communications devices 1306 may transmit circuit component 1320 to another system. Communications devices 1306 may receive processes 1312, user inputs 1314, parameters 1316, and/or circuit component 1320 and cause processes 1312, user inputs 1314, parameters 1316, and/or circuit component 1320 to be stored in memory 1304.

Implementations discussed herein include, but are not limited to, the following examples:

Example 1: A memory component, comprising: a first dynamic random access memory (DRAM) array to store a plurality of cache line information entries, each cache line information entry comprising tag information and cache line status information; a second DRAM array to store a plurality of cache lines; a command/address interface to receive a first access command, in association with a first tag query value and a first address, indicating a first access to the first DRAM array, the first access to the first DRAM array to access a first cache line information entry associated with the first address and including a first tag value and first cache line status information and to access a second cache line information entry associated with a second address and including a second tag value and second cache line status information; and a cache result interface to transmit, based on the first access command, a first status indicator and a second status indicator, the first status indicator including a first hit/miss indication indicating whether the first tag query value matches the first tag value, the second status indicator including a first modification indicator indicating whether a cache line associated with the second cache line information entry is in a modified state.

Example 2: The memory component of example 1, wherein the second cache line information entry is selected from the plurality of cache line information entries as a basis for the first modification indicator based on the second cache line status information indicating that the cache line associated with the second cache line information entry is in the modified state.

Example 3: The memory component of example 1, wherein the cache result interface is to, based on the second cache line status information indicating that the cache line associated with the second cache line information entry is in the modified state, transmit the second tag value.

Example 4: The memory component of example 1, wherein a data interface is to, based on the second cache line status information indicating that the cache line associated with the second cache line information entry is in the modified state, transmit the cache line associated with the second cache line information entry.

Example 5: The memory component of example 1, wherein a data interface is to, based on the first tag query value not matching the first tag value and the second cache line status information indicating that the cache line associated with the second cache line information entry is in the modified state, transmit the cache line associated with the second cache line information entry.

Example 6: The memory component of example 1, wherein the first access to the first DRAM array is to access a third cache line information entry associated with a third address and including a third tag value and third cache line status information, the first cache line information entry including first recency of access information, the second cache line information entry including second recency of access information, the third cache line information entry including third recency of access information, and the second cache line information entry is selected as a basis for the first modification indicator based on the second recency of access information and the third recency of access information.

Example 7: The memory component of example 6, wherein the second cache line information entry is selected as the basis for the first modification indicator based on the second recency of access information and the third recency of access information indicating that a cache line associated with the third cache line information entry has been accessed more recently than the cache line associated with the second cache line information entry.

Example 8: A memory component, comprising: a first dynamic random access memory (DRAM) array to store a plurality of cache line information entries, each cache line information entry comprising tag information and cache line status information; a second DRAM array to store a plurality of cache lines; a command/address interface to receive, from a controller, a first access command, in association with a first address, indicating a first access to the first DRAM array, the first access to the first DRAM array to access a first cache line information entry associated with the first address and including first cache line status information; a cache result interface to, based on the first access command, transmit a first status indicator; and a data interface to communicate cache lines with the controller, the data interface to, based on the first access command and the first cache line information entry indicating that a first cache line stored by the second DRAM array that is associated with the first address is in a modified state, transmit, to the controller, the first cache line.

Example 9: The memory component of example 8, wherein, based on the first access command and the first cache line information entry indicating that the first cache line stored by the second DRAM array that is associated with the first address is in the modified state, setting the first cache line information entry to indicate that the first cache line is not in the modified state.

Example 10: The memory component of example 9, wherein setting the first cache line information entry to indicate that the first cache line is not in the modified state is further based on the memory component being in a first mode.

Example 11: The memory component of example 8, wherein the first status indicator indicates that the first cache line stored by the second DRAM array that is associated with the first address is in the modified state.

Example 12: The memory component of example 8, wherein the first access to the first DRAM array is to further access a second cache line information entry associated with the first address and including second cache line status information, and wherein the memory component selects the first cache line to be transmitted to the controller based on the second cache line information entry indicating a second cache line that is stored by the second DRAM array, that is associated with the first address, and that is associated with the second cache line information entry, is not in the modified state.

Example 13: The memory component of example 8, wherein the first access to the first DRAM array is to further access a second cache line information entry associated with the first address and including second cache line status information, the first cache line information entry including first recency of access information and the second cache line information entry including second recency of access information, and wherein the first cache line is selected for transmission via the data interface to the controller based on the first recency of access information and the second recency of access information.

Example 14: The memory component of example 13, wherein the first cache line is selected for transmission via the data interface to the controller based on the first recency of access information and the second recency of access information indicating that a second cache line that is stored by the second DRAM array, that is associated with the first address, and that is associated with the second cache line information entry, has been accessed more recently than the first cache line.

Example 15: A memory component, comprising: a first dynamic random access memory (DRAM) array to store a plurality of cache line information entries, each cache line information entry comprising tag information and cache line status information; a second DRAM array to store a plurality of cache lines; a command/address interface to receive a first access command, in association with a first tag query value and a first address, indicating a first access to the first DRAM array, the first access to the first DRAM array to access a first cache line information entry associated with the first address and including a first tag value and first cache line status information and to access a second cache line information entry associated with a second address and including a second tag value and second cache line status information; a cache result interface to transmit, based on the first access command, a first status indicator and a second status indicator, the first status indicator including a first hit/miss indication indicating whether the first tag query value matches the first tag value, the second status indicator including a first modification indicator indicating whether a cache line associated with the second cache line information entry and stored by the second DRAM array, is in a modified state; the command/address interface to receive a second access command, in association with the first address, indicating a second access to the first DRAM array, the second access to the first DRAM array to access the second cache line information entry that indicates the cache line associated with the second cache line information entry is in the modified state; and a data interface to, based on the second access command and the second cache line information entry indicating that the cache line associated with the second cache line information entry is in the modified state, transmit the cache line associated with the second cache line information entry.

Example 16: The memory component of example 15, wherein the second access command is further in association with a second tag query value and the second tag value matches the second tag query value.

Example 17: The memory component of example 15, wherein, based on the second access command, the second cache line information entry is to be set to indicate the cache line associated with the second cache line information entry is not in the modified state.

Example 18: The memory component of example 15, wherein, based on the second access command, the cache result interface is to transmit the second tag value.

Example 19: The memory component of example 15, wherein, based on the second access command and the second cache line information entry indicating the cache line associated with the second cache line information entry is the modified state, the cache result interface is to transmit the second tag value.

Example 20: The memory component of example 15, wherein the first access command instructs the memory component to perform a refresh operation.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A memory component, comprising:
a first dynamic random access memory (DRAM) array to store a plurality of cache line information entries, each cache line information entry comprising tag information and cache line status information;
a second DRAM array to store a plurality of cache lines;
a command/address interface to receive a first access command, in association with a first tag query value and a first address, indicating a first access to the first DRAM array, the first access to the first DRAM array to access a first cache line information entry associated with the first address and including a first tag value and first cache line status information and to access a second cache line information entry associated with a second address and including a second tag value and second cache line status information; and
a cache result interface to transmit, based on the first access command, a first status indicator and a second status indicator, the first status indicator including a first hit/miss indication indicating whether the first tag query value matches the first tag value, the second status indicator including a first modification indicator indicating whether a cache line associated with the second cache line information entry is in a modified state.

2. The memory component of claim 1, wherein the second cache line information entry is selected from the plurality of cache line information entries as a basis for the first modification indicator based on the second cache line status information indicating that the cache line associated with the second cache line information entry is in the modified state.

3. The memory component of claim 1, wherein the cache result interface is to, based on the second cache line status information indicating that the cache line associated with the second cache line information entry is in the modified state, transmit the second tag value.

4. The memory component of claim 1, wherein a data interface is to, based on the second cache line status information indicating that the cache line associated with the second cache line information entry is in the modified state, transmit the cache line associated with the second cache line information entry.

5. The memory component of claim 1, wherein a data interface is to, based on the first tag query value not matching the first tag value and the second cache line status information indicating that the cache line associated with the second cache line information entry is in the modified state, transmit the cache line associated with the second cache line information entry.

6. The memory component of claim 1, wherein the first access to the first DRAM array is to access a third cache line information entry associated with a third address and including a third tag value and third cache line status information, the first cache line information entry including first recency of access information, the second cache line information entry including second recency of access information, the third cache line information entry including third recency of access information, and the second cache line information entry is selected as a basis for the first modification indicator based on the second recency of access information and the third recency of access information.

7. The memory component of claim 6, wherein the second cache line information entry is selected as the basis for the first modification indicator based on the second recency of access information and the third recency of access information indicating that a cache line associated with the third cache line information entry has been accessed more recently than the cache line associated with the second cache line information entry.

8. A memory component, comprising:
a first dynamic random access memory (DRAM) array to store a plurality of cache line information entries, each cache line information entry comprising tag information and cache line status information;
a second DRAM array to store a plurality of cache lines;
a command/address interface to receive, from a controller, a first access command, in association with a first address, indicating a first access to the first DRAM array, the first access to the first DRAM array to access a first cache line information entry associated with the first address and including first cache line status information;
a cache result interface to, based on the first access command, transmit a first status indicator; and
a data interface to communicate cache lines with the controller, the data interface to, based on the first access command and the first cache line information entry indicating that a first cache line stored by the second DRAM array that is associated with the first address is in a modified state, transmit, to the controller, the first cache line.

9. The memory component of claim 8, wherein, based on the first access command and the first cache line information entry indicating that the first cache line stored by the second DRAM array that is associated with the first address is in the modified state, setting the first cache line information entry to indicate that the first cache line is not in the modified state.

10. The memory component of claim 9, wherein setting the first cache line information entry to indicate that the first cache line is not in the modified state is further based on the memory component being in a first mode.

11. The memory component of claim 8, wherein the first status indicator indicates that the first cache line stored by the second DRAM array that is associated with the first address is in the modified state.

12. The memory component of claim 8, wherein the first access to the first DRAM array is to further access a second cache line information entry associated with the first address and including second cache line status information, and wherein the memory component selects the first cache line to be transmitted to the controller based on the second cache line information entry indicating a second cache line that is stored by the second DRAM array, that is associated with the first address, and that is associated with the second cache line information entry, is not in the modified state.

13. The memory component of claim 8, wherein the first access to the first DRAM array is to further access a second cache line information entry associated with the first address and including second cache line status information, the first cache line information entry including first recency of access information and the second cache line information entry including second recency of access information, and wherein the first cache line is selected for transmission via the data interface to the controller based on the first recency of access information and the second recency of access information.

14. The memory component of claim 13, wherein the first cache line is selected for transmission via the data interface to the controller based on the first recency of access information and the second recency of access information indicating that a second cache line that is stored by the second DRAM array, that is associated with the first address, and that is associated with the second cache line information entry, has been accessed more recently than the first cache line.

15. A memory component, comprising:
a first dynamic random access memory (DRAM) array to store a plurality of cache line information entries, each cache line information entry comprising tag information and cache line status information;
a second DRAM array to store a plurality of cache lines;
a command/address interface to receive a first access command, in association with a first tag query value and a first address, indicating a first access to the first DRAM array, the first access to the first DRAM array to access a first cache line information entry associated with the first address and including a first tag value and first cache line status information and to access a second cache line information entry associated with a second address and including a second tag value and second cache line status information;
a cache result interface to transmit, based on the first access command, a first status indicator and a second status indicator, the first status indicator including a first hit/miss indication indicating whether the first tag query value matches the first tag value, the second status indicator including a first modification indicator indicating whether a cache line associated with the second cache line information entry and stored by the second DRAM array, is in a modified state;
the command/address interface to receive a second access command, in association with the first address, indicating a second access to the first DRAM array, the second access to the first DRAM array to access the second cache line information entry that indicates the cache line associated with the second cache line information entry is in the modified state; and
a data interface to, based on the second access command and the second cache line information entry indicating that the cache line associated with the second cache line information entry is in the modified state, transmit the cache line associated with the second cache line information entry.

16. The memory component of claim 15, wherein the second access command is further in association with a second tag query value and the second tag value matches the second tag query value.

17. The memory component of claim 15, wherein, based on the second access command, the second cache line information entry is to be set to indicate the cache line associated with the second cache line information entry is not in the modified state.

18. The memory component of claim 15, wherein, based on the second access command, the cache result interface is to transmit the second tag value.

19. The memory component of claim 15, wherein, based on the second access command and the second cache line information entry indicating the cache line associated with the second cache line information entry is the modified state, the cache result interface is to transmit the second tag value.

20. The memory component of claim 15, wherein the first access command instructs the memory component to perform a refresh operation.
